(19) United States
(12) Patent Application Publication
(10) Pub. No.: US 2004/0058137 A1
(43) Pub. Date: Mar. 25, 2004

(54) Aromatic liquid-crystalline polyester film and metal laminated article

(75) Inventors: Satoshi Okamoto, Tsukuba-shi (JP); Tomoya Hosoda, Tsukuba-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO METAL MINING CO., LTD.

(21) Appl. No.: 10/621,388

(22) Filed: Jul. 18, 2003

(30) Foreign Application Priority Data
Jul. 23, 2002 (JP) 2002-213642

(51) Int. Cl. B32B 15/08; B32B 3/00

(52) U.S. Cl. 428/209; 428/458; 428/480; 428/901

(57) ABSTRACT

An aromatic liquid-crystalline polyester film having a low water absorbing property, and additionally, showing small linear expansion coefficient is provided by an aromatic liquid-crystalline polyester film comprising an aromatic liquid-crystalline polyester with a weight average molecular weight of 5000 to 100000, which comprises a structural unit of the following formula (I) derived from p-hydrozybenzoic acid:

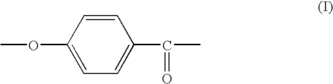

a structural unit of the following formula (II) derived from hydroquinone, dihydroxybiphenyl:

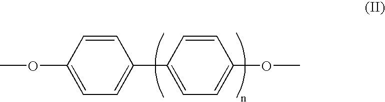

(wherein, n represents 0 or 1), and a structural unit of the following formula (III) derived from naphthalenecarboxylic acid:

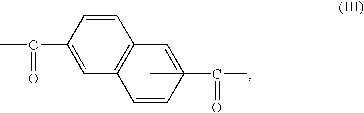

wherein each structural unit combines through ester-bonding.

### FIELD OF THE INVENTION

The present invention relates to an aromatic liquid-crystalline polyester film and a laminated article of an aromatic liquid-crystalline polyester film and a metal layer.

### BACKGROUND OF THE INVENTION

Recently, with development of electric and electronic parts of light weight and small size, there is an increasing demand for flexible printed wiring boards composed of a laminated article of a resin film and a metal layer. In flexible printed wiring boards, a polyimide resin film is generally used, however, there is a problem that a polyimide resin film has a water absorbing property. Therefore, there is an investigation on flexible printed wiring boards obtained by using a laminated article of an aromatic liquid-crystalline polyester film having a low water absorbing property and a metal layer.

However, conventional aromatic liquid-crystalline polyester films have larger linear expansion coefficient as compared with polyimide resin films, consequently, there is a problem of occurrence of peeling at the interface of a metal layer and a resin film.

Then, there has been a desire for development of an aromatic liquid-crystalline polyester film having a low water absorbing property, and additionally, having small linear expansion coefficient.

### SUMMARY OF THE INVENTION

An object of the present invention is to provide an aromatic liquid-crystalline polyester film having a low water absorbing property, and additionally, having small linear expansion coefficient.

The present inventors have intensively investigated to find an aromatic liquid-crystalline polyester film having no problem as described above, and resultantly found that an aromatic liquid-crystalline polyester film made of an aromatic liquid-crystalline polyester obtained by ester-bonding structural units of the following formulae (I) to (III) and having a weight average molecular weight of 5000 to 100000 has a small water absorbing property and additionally has small linear expansion coefficient.

Namely, the present invention provides an aromatic liquid-crystalline polyester film comprising an aromatic liquid-crystalline polyester with a weight average molecular weight of 5000 to 100000, which comprises a structural unit of the following formula (I):

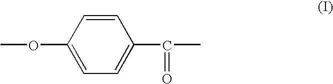

a structural unit of the following formula (II):

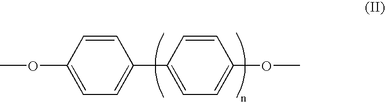

(wherein, n represents 0 or 1), and a structural unit of the following formula (III):

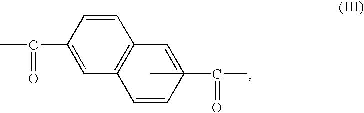

wherein each structural unit combines through ester-bonding.

### DETAILED DESCRIPTION OF THE INVENTION

The present invention will be illustrated in detail below.

The aromatic liquid-crystalline polyester film of the present invention is made of a polyester called thermotropic liquid-crystalline polymer, obtained by ester-bonding structural units of the above-described formulae (I) to (III), and forms an anisotropic molten state at temperatures of 400° C. or lower.

The aromatic liquid-crystalline polyester used in the present invention further comprises a structural unit of the following formula (IV):

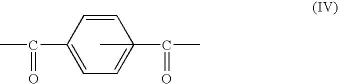

The structural unit (I) is a structural unit derived from p-hydroxybenzoic acid, and from the standpoint of a liquid-crystalline property, the amount of a structural unit derived from p-hydroxybenzoic acid is preferably from 30 to 80% by mole, more preferably from 40 to 70% by mole, further preferably from 55 to 60% by mole based on total structural units.

The structural unit (II) is a structural unit derived from at least one compound selected from the group consisting of hydroquinone and 4,4′-dihydroxybiphenyl, and the mixture of them, a structural unit derived from hydroquinone is preferable.

The structural unit (III) is a structural unit derived from naphthalenedicarboxylic acids, and the structural unit derived from naphthalenedicarboxylic acids may include, for example, 1,4-naphthalenedicarboxylic acid, 1,5-naphthalenedicarboxylic acid, 2,3-naphthalenedicarboxylic acid, 2,6-naphthalenedicarboxylic acid, 2,7-naphthalenedicarboxylic acid and the like. The structural unit (III) may be composed of a structural unit derived from two or more naphthalene dicarboxylic acids. From the standpoint of availability and heat resistance, a structural unit derived from 2,6-naphthalenedicarboxylic acid is preferable.

The structural unit (IV) is composed of a structural unit derived from at least one compound selected from the group consisting of terephthalic acid, isophthalic acid and phthalic acid, and preferable is a structural unit derived from terephthalic acid, isophthalic acid or a mixture of terephthalic acid and isophthalic acid, and more preferable is a structural unit derived from a mixture of terephthalic acid and isophthalic acid.

In the case of an aromatic liquid-crystalline polyester comprising the structural units (I) to (III), the molar ratio ((II)/(III)) of the structural unit (II) to the structural unit (III) is preferably from (95/100) to (100/95).

In the case of an aromatic liquid-crystalline polyester comprising the structural units (I) to (IV), the molar ratio ((II)/[(III)+(IV)]) of the structural unit (II) to the total amount of the structural unit (III) and the structural unit (IV) is preferably from (95/100) to (100/95). The molar ratio (III)/(IV)) of the structural unit (III) to the structural unit (IV) is preferably from (5/95) to (95/5), more preferably from (20/80) to (80/20) from the standpoint of linear expansion coefficient. When the proportion of (III) is less than 5, linear expansion coefficient may increase.

The aromatic liquid-crystalline polyester used in the present invention can be produced, for example, by a method in which a phenolic hydroxyl group of p-hydroxybenzoic acid and hydroquinone is acylated with a fatty anhydride to obtain an acylated substance, then, a carboxyl group of 1,4-naphthalenedicarboxylic acid or a mixture of 1,4-naphthalenedicarboxylic acid and terephthalic acid is transesterified with the acylated substance, and the like.

For controlling molecular weight of an aromatic liquid-crystalline polyester, it is preferable that an imidazole compound is added in an amount of 100 to 1000 ppm as a catalyst in melted condition during transesterification.

After transesterification is performed to obtain a polymerized compound, the polymerized compound is converted into powder form, and the powder is subjected to solid phase polymerization under nitrogen atmosphere by heat treatment. The heat-treatment temperature is from 200 to 400° C., further preferably from 250 to 350° C.

Examples of the imidazole compound include imidazole, 1-methylimidazole, 2-methylimidazole, 4-methylimidazole, 1-ethylimidazole, 2-ethylimidazole, 4-ethylimidazole, 1,2-dimethylimidazole, 1,4-dimethylimidazole, 2,4-dimethylimidazole, 1-methyl-2-ethylimidazole, 1-methyl-4-ethylimidazole, 1-ethyl-2-methylimidazole, 1-ethyl-2-ethylimidazole, 1-ethyl-2-phenylimidazole, 2-ethyl-4-methylimidazole, 2-phenylimidazole, 2-undecylimidazole, 2-heptadecylimidazole, 1-benzyl-2-methylimidazole, 2-phenyl-4-methylimidazole, 1-cyanoethyl-2-methylimidazole, 1-cyanoethyl-2-phenylimidazole, 4-cyanoethyl-2-ethyl-4-methylimidazole, 1-aminoethyl-2-methylimidazole, 1-(cyanoethylaminoethyl)-2-methylimidazole, N-[2-(2-methyl-1-imidazolyl)ethyl]urea, 1-cyanoethyl-2-undecylimidazole, 1-cyanoethyl-2-methylimidazole trimellitate, 1-cyanoethyl-2-phenylimidazole trimellitate, 1-cyanoethyl-2-ethyl-4-methylimidazole trimellitate, 1-cyanoethyl-2-undecylimidazole trimellitate, 2,4-diamino-6-[2′-methylimidazolyl-(1′)]-ethyl-S-triazine, 2,4-diamino-6-[2′-undecylimidazolyl(-(1′))-ethyl-S-triazine], 2,4-diamino-6-[2-ethyl-4-methylimidazolyl-(1′)]-ethyl-S-tri azine, 1-dodecyl-2-methyl-3-benzylimidazolium chloride, N,N′-bis(2-methyl-1-imdazolylethyl)urea, N,N′-(2-methyl-1-imidazolylethyl)adipoamide, 2,4-dialkylimidazole-dithiocarboxylic acid, 1,3-dibenzyl-2-methylimidazolium chloride, 2-phenyl-4-methyl-5-hydroxymethylimidazole, 2-phenyl-4,5-dihydroxymethylimidazole, 1-cyanoethyl-2-phenyl-4,5-bis(cyanoethoxymethyl)imidazole, 2-methylimidazole isocyanuric acid adduct, 2-phenylimidazole isocyanuric acid adduct, 2,4-diamino-6-[2′-methylimidazolyl-(1′)]-ethyl-S-triazine isocyanuric acid adduct, 2-alkyl-4-formylimidazole, 2,4-dialkyl-5-formylimidazole, 1-benzyl-2-phenylimidazole, imidazole-4-dithiocarboxylic acid, 2-methylimidazole-4-dithiocarboxylic acid, 2-undecylimidazole-4-dithiocarboxylic acid, 2-heptadecylimidazole-4-dithiocarboxylic acid, 2-phenylimidazole-4-dithiocarboxylic acid, 4-methylimidazole-5-dithiocarboxylic acid, 4-dimethylimidazole-5-dithiocarboxylic acid, 2-ethyl-4-methylimidazole-5-dithiocarboxylic acid, 2-undecyl-4-methylimidazole-5-dithiocarboxylic acid, 2-phenyl-4-methylimidazole-5-dithiocarboxylic acid, 1-aminoethyl-2-methylimidazole, 1-(cyanoethylaminoethyl)-2-methylimidazole, N-(2-methylimidazolyl-1-ethyl)urea, N,N′-[2-methylimidazolyl(1)-ethyl]-adipoyldiamide, 1-aminoethyl-2-ethylimidazole, 4-formylimidazole, 2-methyl-4-formylimidazole, 4-methyl-5-formylimidazole, 2-ethyl-4-methyl-5-formylimidazole, 2-phenyl-4-methyl-4-formylimidazole and the like.

Among them, 1-methylimidazole and 1-ethylimidazole are preferably used.

The weight average molecular weight of an aromatic liquid-crystalline polyester used in the present invention is from 5000 to 100000, preferably from 10000 to 50000, more preferably from 20000 to 40000, further preferably from 25000 to 35000. When the weight average molecular weight is less than 5000, the film formation is difficult, and when the weight average molecular weight is over 100000, viscosity is high, causing a difficult in handling in the film production.

The method of molding an aromatic liquid-crystalline polyester film of the present invention from an aromatic liquid-crystalline polyester is not particularly restricted, and the method may include, for example, a T die method of extruding a melted aromatic liquid-crystalline polyester from a T die and winding this, an tubular process film formation method of extruding a melted aromatic liquid-crystalline polyester in the form of cylinder from an extruder equipped with an annular dice, and cooling and winding this, a method of further mono-axially drawing an aromatic liquid-crystalline polyester sheet obtained by an injection molding method or extrusion method, a solution cast method of dissolving an aromatic liquid-crystalline polyester in a solvent, then, removing the solvent, and other methods. Among of them, the T die method of extruding a melted aromatic liquid-crystalline polyester from the T die and winding this and the tubular process film formation method of extruding a melted aromatic liquid-crystalline polyester in the form of cylinder from an extruder equipped with an annular dice, and cooling and winding this are preferable.

The solvent used in producing a film by the solution cast method is not particularly restricted providing it can dissolve an aromatic liquid-crystalline polyester, and from the standpoint of solubility, halogen-substituted phenol is preferably used. As the halogen-substituted phenol, for example, 3,5-bistrifluoromethylphenol, pentafluorophenol, tetrafluorophenol, p-chlorophenol and the like are listed.

The aromatic liquid-crystalline polyester film of the present invention may be subjected to a surface treatment. The surface treatment method may include, for example, a corona discharge treatment, flame treatment, sputtering treatment, solvent treatment, UV treatment, plasma treatment and the like.

The aromatic liquid-crystalline polyester film of the present invention can be laminated with a metal layer by, for example, the following methods from (1) to (5), to produce a laminated article.

(1) A method in which an aromatic liquid-crystalline polyester is dissolved in an organic solvent to obtain an aromatic liquid-crystalline polyester solution, this is filtrated by a filter and the like if necessary to remove fine foreign materials contained in the solution, then, this solution is directly cast to give a flat and uniform surface on a metal layer such as a metal foil and the like by various means such as, for example, a roll coater method, dip coat method, spray coat method, spinner coat method, curtain coat method, slot coat method, screen coat method and the like, then, a solvent is removed to obtain an aromatic liquid-crystalline polyester film which is laminated with a metal layer.

(2) A method of laminating an aromatic liquid-crystalline polyester film obtained by extrusion molding or tubular process molding, with a metal layer by thermo compression bonding.

(3) A method of laminating an aromatic liquid-crystalline polyester film obtained by extrusion molding or tubular process molding, with a metal layer by pasting the film to the metal layer with an adhesive.

(4) A method in which an aromatic liquid-crystalline polyester is dissolved in an organic solvent to obtain an aromatic liquid-crystalline polyester solution, this is filtrated by a filter and the like if necessary to remove fine foreign materials contained in the solution, then, this solution is cast to give a flat and uniform surface by various means described in (1), then, a solvent is removed to obtain an aromatic liquid-crystalline polyester film which is laminated with a metal layer by pasting the film to the metal layer by thermo compression bonding.

(5) A method in which an aromatic liquid-crystalline polyester film is laminated with a metal layer by pasting the film to the metal layer with an adhesive instead of thermo compression bonding in the above-mentioned method (4).

The method (1) is preferable from the viewpoint that a film having uniform thickness and showing excellent adhesion with a metal layer can be obtained easily by casting an aromatic liquid-crystalline polyester solution by the above-mentioned various means, then, removing a solvent by drying and the like.

The methods (2) and (4) are preferable from the viewpoint that an aromatic liquid-crystalline polyester film can be crimped easily with a metal layer using a press machine or heating roll around the flow initiation temperature of the film.

The adhesive used in the method (3) and (5) is not particularly restricted, and may include hot melt adhesives, polyurethane adhesives and the like. Among of them, epoxy group-containing ethylene copolymers and the like are preferably used as the adhesive.

As the metal of the metal layer used in the present invention, for example, gold, silver, copper, nickel, aluminum and the like are listed, and copper is preferably used. The thickness of the metal layer is preferably from 1 to 1000 μm, more preferably from 3 to 100 μm. The metal layer of the present invention is preferably a so-called metal foil.

The laminated article of the present invention is a laminated article containing at least two layers comprising an aromatic liquid-crystalline polyester film and a metal layer, and it may include for example, a two-layer structure of the aromatic liquid-crystalline polyester film and metal layer, a three-layer structure obtained by laminating a metal layer on both surfaces of the aromatic liquid-crystalline polyester film, a five-layer structure obtained by laminating the aromatic liquid-crystalline polyester film and metal layer alternately.

The thickness of the laminated article thus obtained is preferably from about 5 to 500 μm, and particularly when a high insulation property is required, it may be 500 μm or more.

The laminated article of the present invention may be subjected to heat treatment if necessary, for the purpose of imparting high strength.

The laminated article of the present invention is suitably used in printed wiring boards and the like since it has a low water absorbing property and small linear expansion coefficient.

### EXAMPLES

The present invention will be illustrated based on examples, but the scope of the present invention is not limited to the examples.

### Production Example 1

Into a reactor equipped with a stirrer, torque meter, nitrogen gas introducing tube, thermometer and reflux condenser was added 835.63 g of p-hydrozybenzoic acid ((I), 6.05 mol), 272.52 g of hydroquinone ((II), 2.475 mol), 374.55 g of 2,6-naphthalenedicarboxylic acid ((III), 1.738 mol), 123.35 g of terephthalic acid ((IV), 0.748 mol), 1349.55 g of acetic anhydride (12.65 mol) and 0.163 g of 1-methylimidazole, stirred at room temperature for 15 minutes, then, the temperature of the mixture was raised while stirring. When the inner temperature reached 145° C., the mixture was stirred for 30 minutes while maintaining the same temperature.

Next, the temperature was raised from 145° C. to 310° C. over 3 hours while distilling off by-product acetic acid and unreacted acetic anhydride. Then, 1.426 g of 1-methylimidazole (hereinafter, referred to as MI) was further added, then, the mixture was kept at the same temperature for 1 hour to obtain an aromatic polyester. The resulted aromatic polyester was cooled to room temperature and ground by a grinder to obtain a powder of an aromatic polyester (particle diameter: from about 0.1 mm to about 1 mm).

The powder obtained above was heated from 25° C. to 250° C. over 1 hour, then, the temperature was raise from 250° C. to 301° C. over 8 hours, then, the mixture was heat-insulated at the same temperature for 5 hours, causing solid phase polymerization. Thereafter, the powder after solid phase polymerization was cooled, to obtain an aromatic polyester powder (weight average molecular weight: 28000).

### Production Example 2

Into a reactor equipped with a stirrer, torque meter, nitrogen gas introducing tube, thermometer and reflux condenser was added 759.66 g of p-hydrozybenzoic acid ((I), 5.50 mol), 302.8 g of hydroquinone ((II), 2.75 mol), 594.52 g of 2,6-naphthalenedicarboxylic acid ((III), 2.75 mol), 1356.01 g of acetic anhydride (12.65 mol) and 0.168 g of 1-methylimidazole as a heterocyclic organic base compound, stirred at room temperature for 15 minutes, then, the temperature of the mixture was raised while stirring. When the inner temperature reached 145° C., the mixture was stirred for 30 minutes while maintaining the same temperature.

Next, the temperature was raised from 145° C. to 310° C. over 3 hours while distilling off by-product acetic acid distilled and unreacted acetic anhydride. Then, 1.687 g of 1-methylimidazole (hereinafter, referred to as MI) was further added, then, the mixture was kept at the same temperature for 1 hour to obtain an aromatic polyester. The resulted aromatic polyester was cooled to room temperature and ground by a grinder to obtain a powder of an aromatic polyester (particle diameter: from about 0.1 mm to about 1 mm).

The powder obtained above was heated from 25° C. to 250° C. over 1 hour, then, the temperature was raise from 250° C. to 307° C. over 8 hours, then, the mixture was heat-insulated at the same temperature for 5 hours, causing solid phase polymerization. Thereafter, the powder after solid phase polymerization was cooled, to obtain an aromatic polyester powder (weight average molecular weight: 32000).

### Production Example 3

Into a reactor equipped with a stirrer, torque meter, nitrogen gas introducing tube, thermometer and reflux condenser was added 911 g of p-hydroxybenzoic acid ((I), 6.6 mol), 409 g of 4,4′-dihydroxybiphenyl ((II), 2.2 mol), 274 g of terephthalic acid ((IV), 1.65 mol), 91 g of isophthalic acid ((IV), 0.55 mol) and 1235 g of acetic anhydride (12.1 mol). The inner of the reactor was purged sufficiently with a nitrogen gas, then, the temperature was raised up to 150° C. over 15 minutes under a nitrogen gas flow, and the mixture was refluxed for 3 hours while keeping the temperature.

Next, the temperature was raised up to 320° C. over 2 hours and 50 minutes while distilling off by-product acetic acid and unreacted acetic anhydride, and the increase in torque being considered as completion of the reaction, the content was removed. The resulted solid was cooled to room temperature, and ground by a grinder, then, heated from room temperature to 250° C. over 1 hour under a nitrogen atmosphere, and the temperature was raised from 250° C. to 288° C. over 5 hours and kept at 288° C. for 3 hours, progressing a solid phase polymerization reaction. Thereafter, the powder after solid phase polymerization was cooled, to obtain an aromatic polyester powder (weight average molecular weight: 26000).

### Example 1

0.3 g of the aromatic liquid-crystalline polyester powder obtained in Production Example 1 was kept for 10 minutes at 270° C. under a condition of 50 kgf/cm², to obtain a tablet of the compression-molded specimen. This specimen was subjected to evaluation of the following physical properties. The results are shown in Table 1.

Linear expansion coefficient: Average linear expansion coefficient was measured at a temperature rising rate of 5° C./minute at from 50 to 100° C. under a load of 3 g using a thermomechanical analyzer TMA-120 manufactured by Seiko Denshi Kogyo KK. (Seiko Instruments Inc.).

Balanced coefficient of water absorption: Water absorption was caused under conditions of 85° C./85% RH, and the coefficient of water absorption was calculated from a change in weight after 168 hours.

1 g of the aromatic liquid-crystalline polyester powder obtained in Production Example 1 was dissolved in 10 g of 3,5-bistrifluoromethylphenol, and the resulted solution was applied on an electrolytic copper foil having a thickness of 18 μm, then, dried at 100° C. for 1 hour on a hot plate, further, heat-treated at 250° C. for 1 hour in a ventilating oven, then, measurement of peel strength was conducted by a tension gauge (manufactured by Ultrasonic Engineering CO., Ltd.). The results are shown in Table 1.

### Example 2

Measurement of peel strength was conducted in the same manner as in Example 1 excepting that obtained in Production Example 2 was used as the aromatic liquid-crystalline polyester film.

### Comparative Example 1

Measurement of peel strength was conducted in the same manner as in Example 1 excepting that obtained in Production Example 3 was used as the aromatic liquid-crystalline polyester film.

TABLE 1

| | | | Comparative |
|---|---|---|---|
| | Example 1 | Example 2 | Example 3 |
| Linear expansion | 139 ppm/° C. | 85 ppm/° C. | 174 ppm/° C. |
| coefficient (50 to | | | |
| 100° C.) | | | |
| Balanced coefficient of | 0.1% | 0.1% | 0.1% |
| water absorption | | | |
| (85° C./85% RH) | | | |
| Peel strength from | 1.0 | 1.1 | 0.7 |
| copper foil (kg/cm) | | | |

According to the present invention, an aromatic liquid-crystalline polyester film having a low water absorbing property, and additionally, showing small linear expansion coefficient can be obtained.

What is claimed is,

1. An aromatic liquid-crystalline polyester film comprising an aromatic liquid-crystalline polyester with a weight average molecular weight of 5000 to 100000, which comprises by a structural unit of the following formula (I): 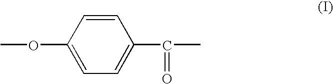
a structural unit of the following formula (ii): 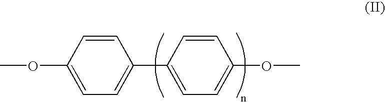
(wherein n represents 0 or 1), and a structural unit of the following formula (III): 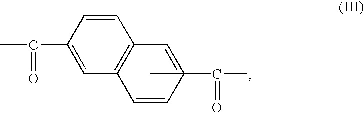
wherein each structural unit combines through ester-bonding.

2. The film according to claim 1, wherein the aromatic liquid-crystalline polyester further comprises a structural unit of the following formula (IV): 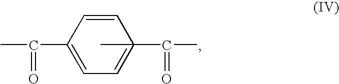
in addition to structural units of the formulae (I), (II) and (III).

3. The film according to claim 1, wherein the amount of (I) is from 40 to 70% by mol based on total structural units and (II)/(III) is from (95/100) to (100/95) in the molar ratio.

4. The aromatic liquid-crystalline polyester film according to claim 1 or 3, wherein the amount of (I) is from 55 to 60% by mol based on total structural units.

5. The film according to claim 1, wherein the structural unit (II) is a structural unit derived from hydroquinone and the structural unit (III) is a structural unit derived from 2,6-naphthalenedicarboxylic acid.

6. The film according to claim 2, wherein the amount of (I) is from 40 to 70% by mol based on total structural units, (III)/(IV) is from (95/5) to (5/95) in the molar ratio and (II)/[(III)+(IV)] is from (95/100) to (100/95) in the molar ratio.

7. The film according to claim 2, wherein the amount of (I) is from 55 to 60% by mol based on total structural units and (III)/(IV) is from (80/20) to (20/80) in the molar ratio.

8. The film according to any one of claims 2, wherein the structural unit (II) is a structural unit derived from hydroquinone, the structural unit (III) is a structural unit derived from 2,6-naphthalenedicarboxylic acid and the structural unit (IV) is a structural unit derived from terephthalic acid, derived from isophthalic acid, or derived from a mixture of terephthalic acid and isophthalic acid.

9. A laminated article obtained by laminating the film according to any one of claim 1 or 2 and a metal layer.

10. The laminated article according to claim 9, wherein the metal layer is a metal layer of at least one metal selected from the group consisting of gold, silver, copper, nickel and aluminum.

11. The laminated article according to claim 10, wherein the metal layer is a copper layer.

12. A printed wiring board obtained by using the laminated body according to any one of claims 9 to 11.
